(19) United States
(12) Patent Application Publication
(10) Pub. No.: US 2011/0024038 A1
(43) Pub. Date: Feb. 3, 2011

(54) RESIN COMPONENT WELDING APPARATUS AND METHOD OF WELDING RESIN COMPONENTS

(76) Inventor: Atsuhiro Mori, Shizuoka-ken (JP)

Correspondence Address: Hershkovitz & Associates, LLC, 2845 Duke Street, Alexandria, VA, 22314, US

(21) Appl. No.: 12/843,755

(22) Filed: Jul. 26, 2010

(30) Foreign Application Priority Data
Jul. 30, 2009 (JP) 2009-177440

(51) Int. Cl. B29C 65/10; C09J 5/10

(52) U.S. Cl. 156/322; 156/497

(57) ABSTRACT

A resin component welding apparatus and method are for welding joint faces of resin components with each other. The apparatus has supporting members which support respective resin components in an axial direction with the joint faces movable to each other along the axial direction; a hot air die having nozzle faces and moveable from an inserting position to a retracting position between both resin components; first driving means for moving said supporting members to a heating position wherein joint faces of respective resin components come close to the nozzle faces of said hot air die located at an inserting position, or to a welding position wherein joint faces of respective resin components are pressure-contacted to each other under the condition of said hot air die located at the retracting position; and second driving means for moving said hot air die between inserting and retracting positions, wherein said hot air die provides a hot air circuit that has a hot air generating structure.

### BACKGROUND OF THE INVENTION

1. Field of the Invention

The present invention relates to a welding apparatus for welding thermoplastic resin components with each other and a method of welding the same.

2. Related Background of the Invention

Conventionally, in a case of welding a housing and a lens of an automobile lamp with each other, hot plate welding methods of wide application have been mainly employed.

Such welding of a housing and a lens of an automobile lamp by a hot plate welding method is carried out by a resin component welding apparatus (hereinafter, referred to as a welding apparatus 1) illustrated in FIGS. 5A through 8, for example.

According to said welding apparatus 1, as illustrated in FIGS. 5A through 8, said welding apparatus 1 has the lower clamping jig 4, an upper clamping jig 5, and a hot die 6 therein respectively at predetermined retracting positions, and one of resin components to be joined, that is, a housing 2 is mounted on an upper portion 4a of said lower clamping jig 4 and also the other resin component to be joined, that is, a lens 3 is mounted on a lower portion 5a of said upper clamping jig 5.

In this state, the hot die 6 is moved to a heating position.

Subsequently, said lower clamping jig 4 is lifted up to the heating position, and also said upper clamping jig 5 is lowered down to the heating position to make a joint face 2a of the housing 2 in contact with a heating face 6a in a lower part of the hot die 6 and also to make a joint face 3a of the lens 3 in contact with a heating face 6b in an upper part of the hot die 6.

By this step, the joint face 2a of the housing 2 and the joint face 3a of the lens 3 become in a molten state due to the heating by the hot die 6.

Then, after passing a predetermined period of time, said lower clamping jig 4 is lowered and also said upper clamping jig 5 is lifted to be moved to the predetermined retracting positions respectively, and said hot die 6 is moved to a predetermined retracting position.

After that, said lower clamping jig 4 is lifted up to a welding position and also said upper clamping jig 5 is lowered down to the welding position, and thus the joint face 2a of the housing 2 is pressure-bonded to the joint face 3a of the lens 3.

Thus, the molten joint faces 2a and 3a of the housing 2 and the lens 3 are pressure-bonded to each other and hardened as they are naturally cooled, thereby welding the housing 2 and the lens 3 with each other (refer to FIG. 6).

Lastly, said lower clamping jig 4 is lowered and also said upper clamping jig 5 is lifted to be moved to the predetermined retracting positions respectively, and the housing 2 and the lens 3 that are welded and integrated to each other are removed.

In such a manner, the welding of the housing 2 and the lens 3, which are resin components, is finished by said function of the welding apparatus 1.

In addition, a hot-air welding method is disclosed in Patent Document 1 (Japanese Patent Publication No. S62-58300) in which two objects to be joined are held with annular joint faces of end portions thereof facing each other with a slight space and, in a state of a hot air nozzle being adjacent to the region of the joint faces from outside, hot air is blown toward the region of said joint faces from the hot air nozzle to melt the region of said joint faces while rotating the objects to be joined at a constant speed, and then the joint faces of the objects to be joined are pressure-bonded to each other and are naturally cooled.

### SUMMARY OF THE INVENTION

### Problems to be solved by the Invention

In a hot plate welding method in the conventional example described above, however, the joint faces of the objects to be joined, that is, welding portions are made in contact directly with the hot die for heating. For this reason, there may be foam produced in the joint faces, a resin spreading out of the molten portions, burrs generated, or the like, and the external appearance after welding and the merchantability turn out to be impaired.

That is, in the welding apparatus 1 illustrated in FIGS. 5A through 8, the heating face 6b of the hot die 6, for example, is made in contact directly with the joint face 3a of the lens 3 in the heated state and the joint face 3a is heated into a molten state.

For this reason, the surface of the joint face 3a of the lens 3 turns out to be thermally fractured and be stretched for the molten residue.

Accordingly, in the subsequent welding step, the joint faces 2a and 3a of the housing 2 and the lens 3 are pressure-contacted and welded with each other, and thereby the completed resin component turns out to have molten resin materials spread out of the joint faces 2a and 3a as illustrated in FIG. 8.

In order to make the amounts of the foams and the spread resin as small as possible for such defects, the hot die is subjected to a surface treatment and also the welding is carried out at a low temperature considering the thermal temperature limit on the surfaces. Accordingly, since it is not possible to heat the joint faces of the resin components up to a temperature sufficient for welding, the original welding strength turns out not to be obtained.

Further, in a case of applying a surface treatment in the above method, since the treatment coating is thin on the surface of the hot die, deterioration due to the contact wear is fast and the lifecycle becomes short, and a hot air die has to be replaced periodically. For this reason, there used to be a defect of seriously increasing the costs and efforts, such as that a spare hot die has to be prepared and the replaced hot die is subjected to a surface treatment and also an operation of hot die replacement is required.

In addition, in the welding method according to Patent Document 1, while the objects to be joined are rotated, the region of the joint faces of the objects to be joined is heated by blowing hot air from one side with the hot air nozzle. Accordingly, the objects to be joined has to be rotated one turn in order to heat the entire region of the annular joint faces, and there used to be such a defect that, during a period of rotating the objects to be joined one turn, the firstly heated portion of the region of the joint faces of the objects to be joined is cooled and non-uniformity is generated in welding strength with respect to its circumferential direction.

In addition, in a case of an unusual circumferential shape of the region of the joint faces of the objects to be joined, the hot air nozzle has to radially approach or depart relative to the rotation axis in sync with the rotation of the objects to be joined, which makes the support structure of the hot air nozzle and the positional control thereof complex so that this is unsuitable for three dimensional structures.

In view of the above defects, it is an object of the present invention to provide a resin component welding apparatus and a method of welding resin components that have a simple configuration not to impair the external appearance and to be capable of securely welding the resin components to each other even in three dimensional shapes of complex welding lines.

### Means for Solving the Problems

According to a first configuration of the present invention, the above object is achieved by a resin component welding apparatus that heats joint faces of two resin components formed of a thermoplastic resin respectively into a molten state and pressure-bonds them, to thereby weld the resin components with each other on the joint faces, the welding apparatus comprising: supporting members that support the respective resin components in an axial direction with the joint faces facing each other and are arranged to be movable to each other along the axial direction; a hot air die disposed movably in directions vertical and horizontal to the axial direction from an inserting position to a retracting position between both of the resin components supported by said supporting members; first driving means for moving said supporting members to heating positions in which the joint faces of the respective resin components come close to nozzle faces of said hot air die with a predetermined space in a state of said hot air die being located at the inserting position, or to welding positions in which the joint faces of the respective resin components are pressure-contacted to each other in a state of said hot air die being located at the retracting position; and second driving means for moving said hot air die between the inserting position and the retracting position, wherein said hot air die includes, for each nozzle face, a hot air circuit that has a hot air generating structure and faces the joint face of each resin component brought to the heating position.

In the resin component welding apparatus according to the present invention, it is preferred that the hot air generating structure of said hot air die is disposed in correspondence with the joint face of the resin component to be heated.

In the resin component welding apparatus and the method of welding resin components according to the present invention, it is preferred that said hot air generating structure is a hot air blowing nozzle.

In the resin component welding apparatus according to the present invention, it is preferred that the apparatus has a structure in which a space between the hot air blowing nozzle of the nozzle face of the hot air die located at the inserting position and the facing joint face of the resin component is from 0.1 to 10 mm, and the hot air blowing nozzle has a nozzle width of from 0.03 to 5 mm and a nozzle diameter of from φ0.05 to φ5 mm.

In addition, in the resin component welding apparatus and the method of welding resin components according to the present invention, it is preferred that the hot air die of said hot air generating structure is equipped with a guide for the hot air blowing nozzle.

In the resin component welding apparatus according to the present invention and the method of welding resin components, it is preferred that the hot air generating structure of said hot air die includes a hot air blowing nozzle capable of bringing an appropriate molten state at an air pressure, an air volume, an air direction, and a temperature range suitable for welding.

In the resin component welding apparatus and the method of welding resin components according to the present invention, it is preferred that said hot air blowing nozzle has a structure in which it can be inserted into a narrow portion even for a structure or a shape having a deep groove in the joint face of the resin component to be heated.

In the resin component welding apparatus and the method of welding resin components according to the present invention, it is preferred that, in order to send stable hot air from the nozzle into the hot air circuit, a structure of special treatment, meshed shape, coiled shape, or the like is laid in a die structure, and further a guide structure is provided to arrange a hot air direction.

In addition, according to a second configuration of the present invention, the above object is achieved by a method of welding resin components, in which joint faces of two resin components formed of a thermoplastic resin are respectively heated into a molten state and pressure-bonded, and thereby the resin components are welding with each other on the joint faces, the method comprising: a first step of supporting the respective resin components axially with the joint faces facing each other; a second step of subsequently causing a hot air generating structure to get relatively close to the joint face of the respective resin component with a predetermined space; a third step of subsequently blowing hot air from said hot air generating structure to heat the joint face of each of said resin components contactlessly into a molten state; and a fourth step of thereafter pressure-contacting the joint faces of the respective resin components to each other for welding.

In the method of welding resin components according to the present invention, it is preferred that said hot air blowing nozzle is disposed in correspondence with the joint face of the resin component to be heated, and in the third step, the joint face of the resin component is simultaneously heated across an entire circumference thereof by the hot air blown from said hot air blowing nozzle.

In the method of welding resin components according to the present invention, it is preferred that, in said second step, said hot air blowing nozzle is caused to come close to the facing joint face of the resin component with a space of from 0.1 to 10 mm and has a structure having a nozzle width of from 0.03 to 5 mm and a nozzle diameter of from φ0.05 to φ5 mm.

### EFFECTS OF THE INVENTION

According to the above configurations, said hot air die is moved to the inserting position and also the supporting members that support the resin components are caused to axially come close to each other and moved to the heating position.

In this state, hot air is blown from hot air blowing nozzle opened in the heating faces of the hot air die, thereby heating the joint faces of the resin components facing the hot air blowing nozzle into a molten state.

Subsequently, the supporting members that support the resin components are moved to their predetermined retracting positions and also the hot air die is moved to its predetermined retracting position, and then the supporting members are caused to axially come close to each other and moved to the welding position.

This makes the joint faces of the resin components supported by the supporting members are pressure-bonded to each other and the resin materials in a molten state are integrated, and thereby the resin components are welded to each other on their joint faces.

After that, the joint faces of the resin components are cooled due to, for example, natural cooling and the resin materials are hardened, and thus the welding of the resin components is finished.

In this case, the joint faces of the resin components to be welded are disposed with a predetermined space without making in contact directly with the heating faces of said hot air die and the hot air blowing nozzle provided in these heating faces face said joint faces. Then, hot air is blown from the hot air blowing nozzle, thereby heating said facing joint faces into a molten state.

Accordingly, different from the conventional hot plate welding method, since the joint faces of the resin components are heated contactlessly, the joint faces of the resin components are not thermally fractured due to the heating without causing foams to be produced and the joint faces to be stretched circumferentially.

For this reason, there is no molten resin material spread out of the joint faces of the resin components after welding the resin components, and the welded resin components are remarkably improved in the external appearance and the merchantability.

Further, although the entire welding apparatus has a structure almost similar to that of the welding apparatus 1 by the conventional hot plate welding method illustrated in FIGS. 5A through 8, it has a function capable of establishing melting conditions thereof by having, in contrast with a hot die, a hot air die that is equipped with a hot air blowing nozzle and hot air circuits for the hot air blowing nozzle and appropriately giving the air pressure, the air volume, the air velocity, the air direction, and the hot air temperature to welding rib faces, and is established as a configuration of an integrated system.

Accordingly, high quality welding of resin components can be carried out.

Since the hot air blowing nozzle of said hot air die is disposed in correspondence with the joint face of the resin component to be heated, the joint face is simultaneously heated across the entire circumference into a molten state, which does not require the rotation driving of the resin components themselves and the positional adjustment of the hot air nozzles accompanied by that as in the welding method according to Patent Document 1, for example.

Since the space between the hot air blowing nozzle of the heating face of the hot air die at the inserting position and the joint face of the facing resin component is from 0.1 to 10 mm, the temperature of the hot air is not excessively decreased until the hot air blown from the hot air blowing nozzle reaches the joint face of the resin component and also the joint face of the resin component can be securely heated.

Since the amount of heat from the hot air blown from the hot air blowing nozzle is increased in a case of said space being less than 0.1 mm, a function of adjusting the blowing pressure of hot air is provided.

In addition, although the above space is shown in an appropriate range, in a case of the space being exceeding 10 mm, the temperature is decreased excessively until the hot air blown from the hot air blowing nozzle reaches the joint face of the resin component, and it turns out not to be able to uniformly heat the joint face of the resin component.

In these cases, it turns out to be unable to appropriately heat, to release hot air, or to produce nonuniformity in melting to make a wide range to be in a heated state, which causes a trouble in other portions.

According to the above configurations, since an air resistance member, such as a structure laid in the hot air circuits, is structured to give resistance, the variation in the amount of hot air emitted from the tip ends of the nozzles can be thus eliminated.

In addition, according to the above configurations, said hot air generating structure (hot air blowing nozzle) is disposed in correspondence with the joint face of the resin component and a molten state can be brought within a temperature range suitable for welding.

Further in addition, according to the above configurations, said hot air blowing nozzle can be inserted into a narrow portion even for a structure or a shape having a deep groove in the joint face of the resin component to be heated.

In the present invention, the hot air die is equipped with a guide to keep the nozzle width of the hot air blowing nozzle, which is said hot air generating structure, to be constant, and thereby the variation in the nozzle width can be prevented due to the expansion and contraction of the hot air die as the temperature rises. In particular, in the present invention, since the hot air die is equipped with guide ribs therein with a constant space, the functional effects are significant.

Still in addition, according to the above configurations, by using a heat conductive medium of, not limited to air, but hydrogen gas, helium gas, or the like with higher specific heat, it becomes possible to remarkably reduce the heating time period upon welding the resin component and it is also possible to obtain an advantage on production costs.

Nitrogen gas, carbon dioxide gas, oxygen, and argon gas also can obtain effects equivalent to those of air.

As described above, according to the present invention, it becomes possible to provide a resin component welding apparatus and a method of welding resin components that have a simple configuration not to impair the external appearance and to be capable of securely welding the resin components to each other.

### BRIEF DESCRIPTION OF THE DRAWINGS

FIGS. 1A and 1B are schematic cross-sectional views illustrating a configuration of one embodiment of a resin component welding apparatus according to the present invention.

FIG. 2 is a schematic cross-sectional view illustrating a welding step of a main area in the welding apparatus in FIGS. 1A and 1B.

FIGS. 3A to 3I are process drawings of a method of welding resin components using the resin component welding apparatus according to the present invention.

FIG. 4 is a schematic cross-sectional view of a welded resin component obtained by the present invention.

FIGS. 5A and 5B are schematic cross-sectional views illustrating a melting step in a conventional welding apparatus.

FIG. 6 is a schematic cross-sectional view illustrating a welding step of FIGS. 5A and 5B.

FIGS. 7A to 7I are process drawings of a method of welding resin components using a conventional welding apparatus.

FIG. 8 is a schematic cross-sectional view of a welded resin component obtained by FIGS. 5A and 5B.

### DESCRIPTION OF THE PREFERRED EMBODIMENTS

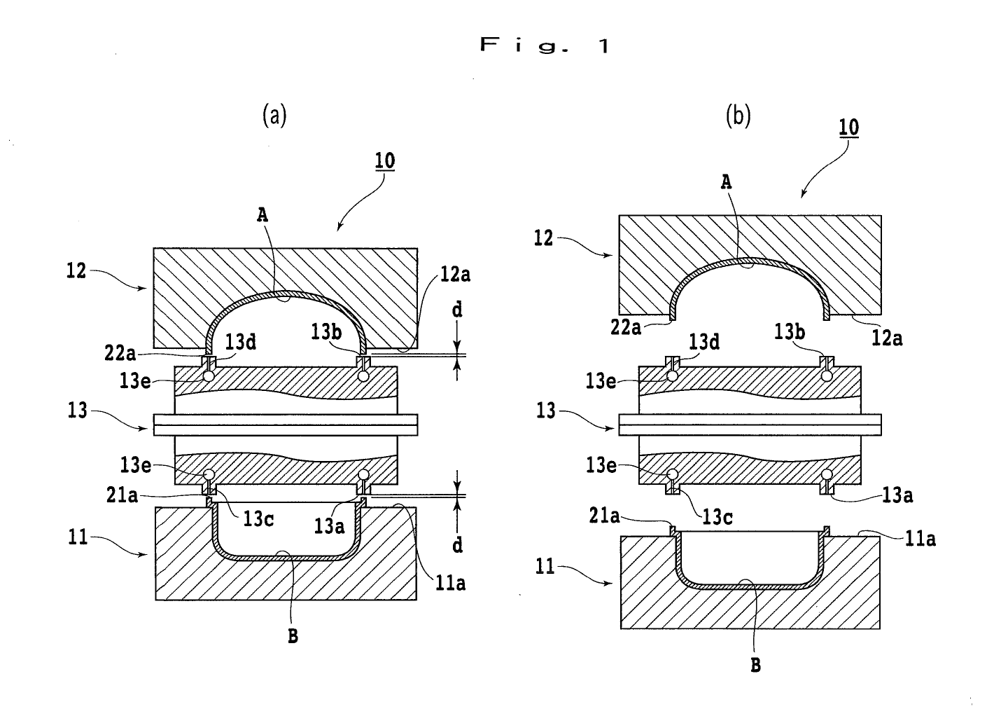

A detailed description is given below to preferred embodiments of the present invention with reference to FIGS. 1A through 4.

It should be noted that, although the embodiments described below are preferred specific examples for the present invention so that technically preferred various limitations are given, the scope of the present invention is not limited to these modes unless not specified particularly to limit the present invention in the description below.

FIGS. 1A and 1B illustrate a configuration of one embodiment of a resin component welding apparatus (hereinafter, referred to as a welding apparatus 10) of the present invention.

In FIGS. 1A and 1B, the welding apparatus 10 is configured with a lower clamping jig 11 and an upper clamping jig 12 to support components A and B that are resin components formed of a thermoplastic resin, a hot air die 13, first driving means (not shown, same below) vertically driving said lower clamping jig 11 and upper clamping jig 12, and second driving means (not shown, same below) horizontally driving said hot air die 13. In addition, not only the upper and lower clamping jig layout but also those using right and left driving means are similar.

Here, said components A and B are components for an automobile lamp and are molded from a thermoplastic resin, respectively.

These components A and B are configured to be hollow respectively, and joint faces 21a and 22a of welding ribs provided on peripheries of open ends thereof are welded to each other, thereby sealing the inside.

Said lower clamping jig 11 has an upper portion 11a that holds said component B in an upward direction, that is, directing the joint face 21a upwardly and also is supported movably along the axial direction extending vertically.

In contrast, said upper clamping jig 12 has a lower portion 12a that holds said component A in a downward direction, that is, directing the joint face 22a downwardly and also is supported movably along the axial direction extending vertically.

Here, said lower clamping jig 11 and upper clamping jig 12 are moved from predetermined retracting positions to heating positions or welding positions along the axial direction in directions approaching to each other by the first driving means.

Said hot air die 13 has a lower face and an upper face provided respectively with nozzle faces 13a and 13b across the entire circumference facing the joint faces 21a and 22a of said components A and B in a shape close to the joint faces.

In addition, said hot air die 13 is supported movably in a direction vertical to the axis of said lower clamping jig 11 and upper clamping jig 12, that is, horizontally.

Here, said hot air die 13 is moved from a predetermined retracting position to an inserting position by the second driving means.

Said first driving means is known driving means and moves said lower clamping jig 11 and upper clamping jig 12 in the directions of approaching or departing from each other along the axial direction. Said second driving means is known driving means and moves said hot air die 13 in a horizontal direction vertical to the axial direction.

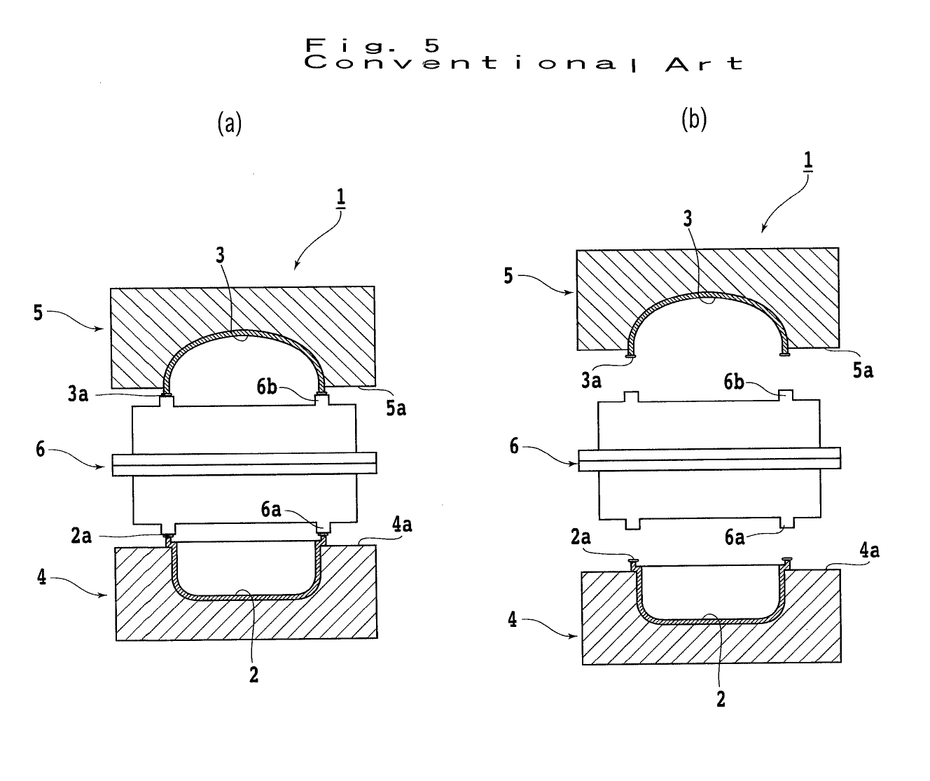

Although the above configuration is almost similar to that of the conventional welding apparatus illustrated in FIGS. 5A and 5B, the welding apparatus 10 according to an embodiment of the present invention has a configuration different in the points below.

That is, said hot air die 13 includes hot air blowing nozzles 13c and 13d having the nozzle faces 13a and 13b thereof opened at positions facing the joint faces 21a and 22a of the components A and B at the heating positions described above.

These hot air blowing nozzles 13c and 13d are connected to a hot air source, not shown, via hot air circuits 13e formed in said hot air die 13, and when heating, they blow hot air from the hot air source to the facing joint faces 21a and 22a of the components A and B for heating.

Here, the temperature of the hot air is selected to be a temperature that can heat the resin material configuring the joint faces 21a and 22a of the components A and B up to be in a molten state when reaching the joint faces 21a and 22a blown from said hot air blowing nozzles 13c and 13d, which is, for example, from 100 to 500° C. and preferably from 140 to 400° C. approximately.

In addition, said lower clamping jig 11 and upper clamping jig 12 are disposed to make the joint faces 21a and 22a of the supporting components A and B to be normally facing vertically with a predetermined space d to the nozzle faces 13a and 13b of said hot air die 13.

Because of this, the nozzle faces 13a and 13b of said hot air die 13 are not in contact directly with the respective joint faces 21a and 22a of the components A and B and blow hot air contactlessly to the respective joint faces 21a and 22a for heating.

Here, said predetermined space d is selected to be a distance capable of not excessively decreasing the temperature of hot air until the hot air blown from the hot air blowing nozzle 13c and 13d reaches the joint faces 21a and 22a of the components A and B and also of securely heating said joint faces 21a and 22a, which is, for example, from 0.1 to 10 mm approximately.

In a case of said space being less than 0.1 mm, since the amount of heat of the hot air blown from the hot air blowing nozzles 13c and 13d is increased, a function of adjusting the blowing pressure of hot air is provided. For this reason, it is possible to prevent variation in melting.

In addition, in a case of said space exceeding 10 mm, the temperature is decreased excessively until hot air blown from the hot air blowing nozzles 13c and 13d reaches said joint faces 21a and 22a, and it turns out not to be able to heat said joint faces 21a and 22a sufficiently. There is also a possibility of causing a trouble in another portion for spreading the temperature to wider regions.

Therefore, said preferred predetermined space d is from 0.1 to 10 mm approximately.

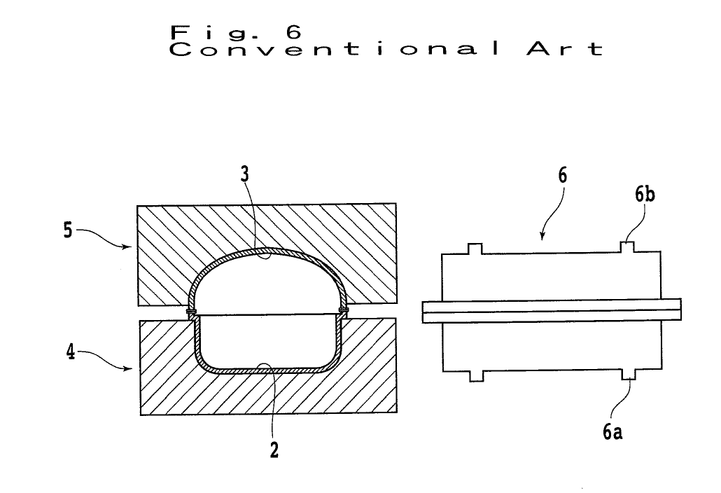

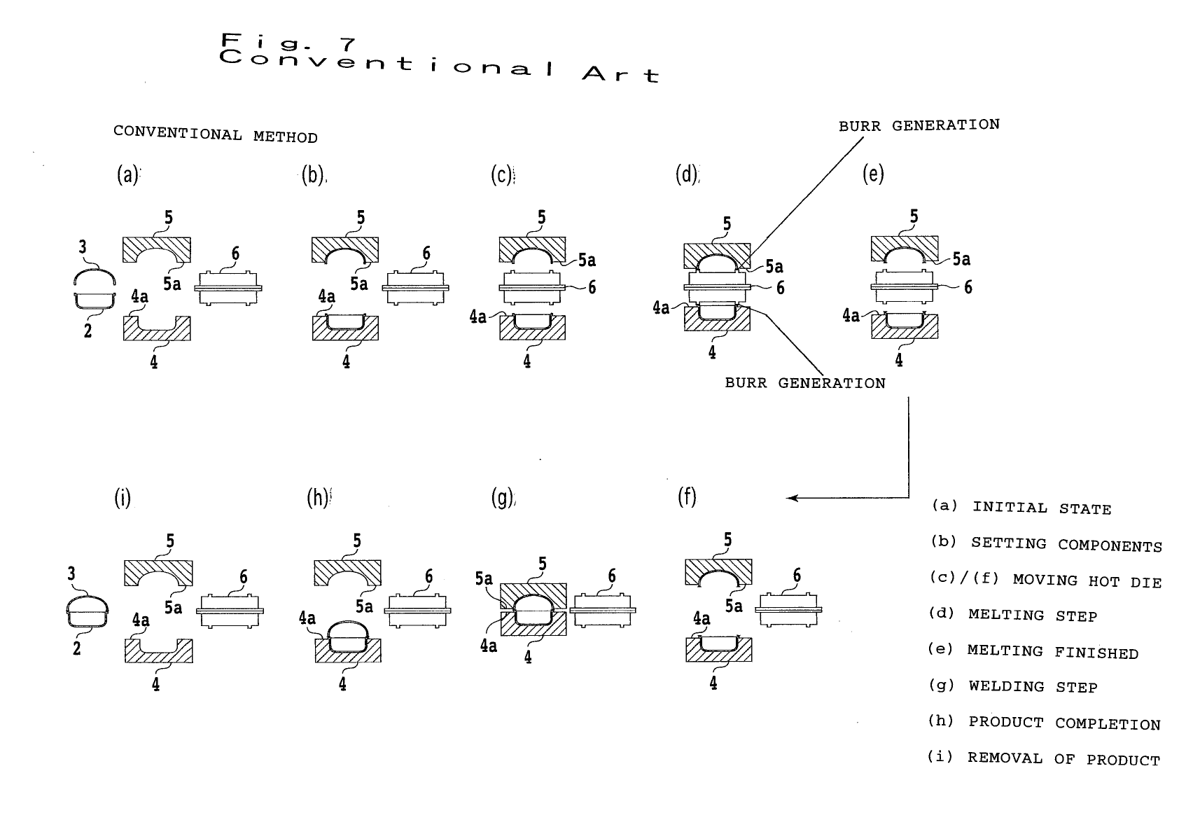

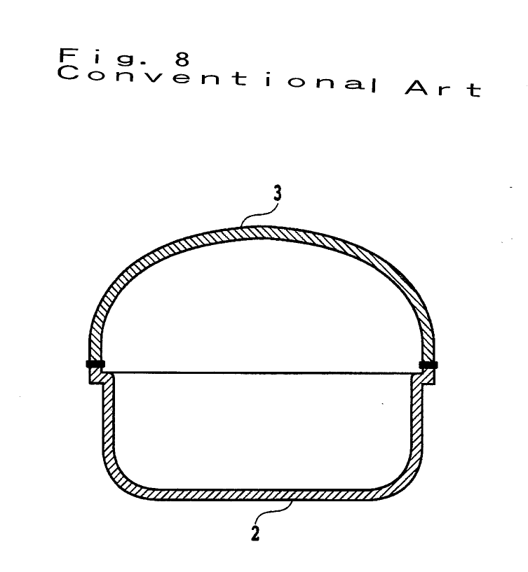

The welding apparatus 10 according to the present invention is configured as above, and behaves as below. A detailed description is given below to the process drawings in FIGS. 1A and 1B and FIGS. 3A to 31.

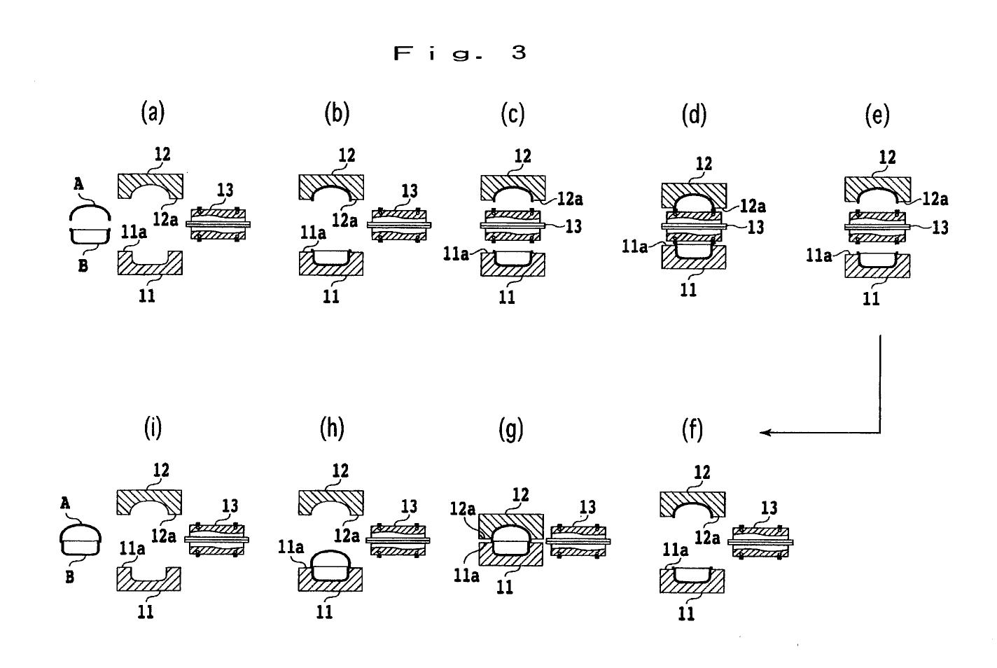

That is, as illustrated in FIGS. 3A and 3B, said lower clamping jig 11, said upper clamping jig 12, and said hot air die 13 are at the respective predetermined retracting positions, and one of the resin components to be joined, that is, the component B is placed in the upper portion 11a of said lower clamping jig 11 and also the other resin component to be joined, that is, the component A is placed in the lower portion 12a of said upper clamping jig 12.

In this state, as illustrated in FIG. 3C, the hot air die 13 is moved to the heating position by the second driving means.

Subsequently, as illustrated in FIGS. 3D and 3E (corresponding to FIGS. 1A and 1B), said lower clamping jig 11 is lifted up to the heating position by said first driving means and also said upper clamping jig 12 is lowered down to the heating position to move the joint face 21a of the component B to a position with the predetermined space d from the nozzle face 13a in the lower part of the hot air die 13 and also to move the joint face 22a of the component A to a position with the predetermined space d from the nozzle face 13b in the upper part of the hot air die 13 by said second driving means.

Here, hot air is blown from the hot air blowing nozzles 13c and 13d provided in the nozzle faces 13a and 13b of said hot air die 13 toward the joint face 22a of the component A and the joint face 21a of the component B.

Thus, the joint face 21a of the component B and the joint face 22a of the component A are heated by hot air from the hot air blowing nozzles 13c and 13d of the hot air die 13 to be in a molten state.

Then, after passing a predetermined period of time, as illustrated in FIGS. 3E and 3F, said lower clamping jig 11 is lowered down and also said upper clamping jig 12 is lifted by said first driving means to be moved to the predetermined retracting positions, and said hot air die 13 is moved to the predetermined retracting position by said second driving means.

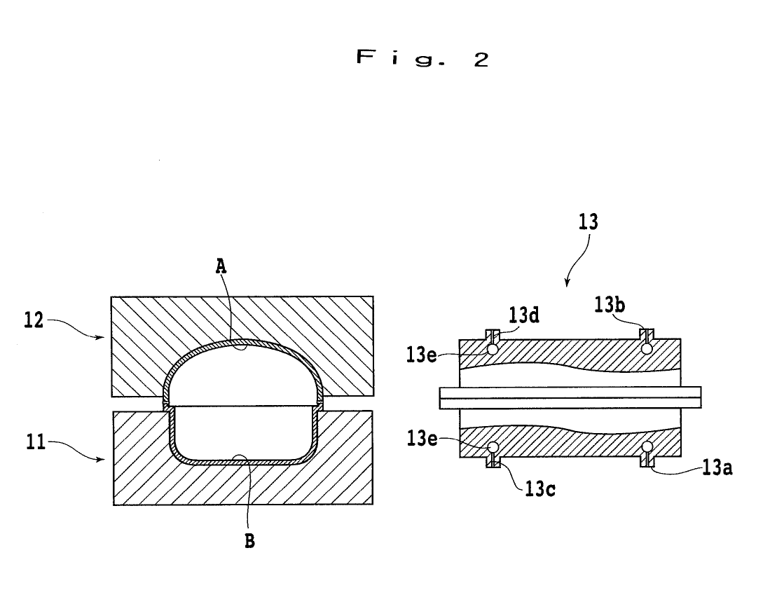

After that, as illustrated in FIGS. 3G and 2, which is an enlarged view, said lower clamping jig 11 is lifted up to the welding position and also said upper clamping jig 12 is lowered down to the welding position by said first driving means to pressure-bond the joint face 21a of the component B to the joint face 22a of the component A.

Thus, the molten joint faces 21a and 22a of the components A and B are pressure-bonded to each other and are hardened as they are naturally cooled, and thereby the components A and B are welded to each other.

Lastly, as illustrated in FIGS. 3H and 3I, said lower clamping jig 11 is lowered down and also said upper clamping jig 12 is lifted up by said first driving means to be moved to the retracting positions to remove the components A and B welded and integrated to each other.

In such a manner, the welding of the components A and B, which are resin components, is finished by the welding apparatus 10.

In this case, as illustrated in FIGS. 1A and 1B, the nozzle faces 13a and 13b of said hot air die 13 are moved to a position of approaching the joint faces 21a and 22a of the components A and B, which are resin components, spaced with the predetermined space d, and from this state, hot air blown from the hot air blowing nozzles 13c and 13d opened in the nozzle faces 13a and 13b of said hot air die 13 is blown on the joint faces 21a and 22a of the components A and B, thereby heating the joint faces 21a and 22a of the components A and B.

For this reason, the nozzle faces 13a and 13b of the hot air die 13 are not made in contact directly with the facing joint faces 21a and 22a of the components A and B, respectively, when heating, which turns out to heat contactlessly.

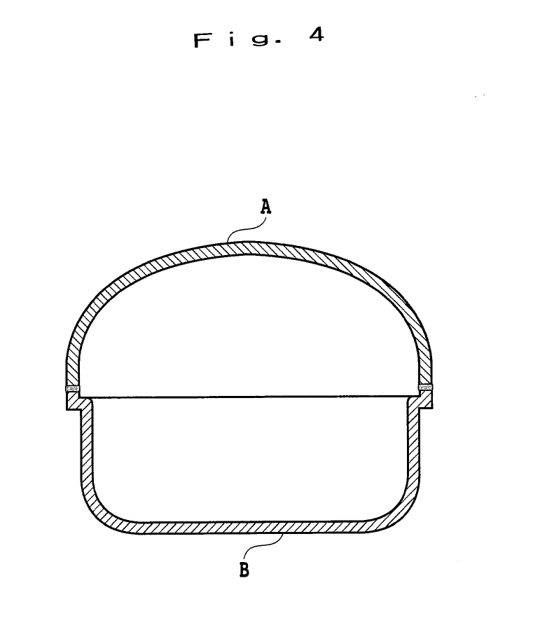

Accordingly, as illustrated in FIG. 4, since the components A and B welded to each other have the joint faces 21a and 22a, of the components A and B, in which no foams are produced or no molten resin material spreads out, there is no burr generated and the external appearance is not impaired, and the merchantability is remarkably improved.

Regarding the heating, in spite of the above description, it is also possible 1) to utilize heat generated upon heating a main body or 2) to provide a heat source separately (externally).

### INDUSTRIAL APPLICABILITY

Although the embodiments mentioned above describe a case of welding the components (a housing and a lens) for an automobile lamp as the resin components, it is obvious that the present invention is also applicable to cases of welding a wide variety of other thermoplastic resin components not limited to them.

In such a manner, according to the present invention, it is possible to provide a resin component welding apparatus and a method of welding resin components that have a simple configuration not to impair the external appearance and to be capable of securely welding the resin components to each other.

1. A resin component welding apparatus that heats joint faces of a plurality of resin components formed of a thermoplastic resin respectively into a molten state and pressure-bonds them, to thereby weld the resin components with each other on the joint faces, the welding apparatus comprising:
supporting members that support the respective resin components in an axial direction with the joint faces facing each other and are arranged to be movable to each other along the axial direction;
a hot air die disposed movably in directions vertical and horizontal to said axial direction from an inserting position to a retracting position between both of the resin components supported by said supporting members
first driving means for moving said supporting members to heating positions in which the joint faces of the respective resin components come close to nozzle faces of said hot air die with a predetermined space in a state of said hot air die being located at the inserting position, or to welding positions in which the joint faces of the respective resin components are pressure-contacted to each other in a state of said hot air die being located at the retracting position; and
second driving means for moving said hot air die between the inserting position and the retracting position, wherein
said hot air die includes, for each nozzle face, a hot air circuit that has a hot air generating structure and faces the joint face of each resin component brought to the heating position.

2. The resin component welding apparatus according to claim 1, wherein said hot air generating structure is a hot air blowing nozzle.

3. The resin component welding apparatus according to claim 1, in which a welding line of the resin component corresponds to a complex three dimensional shape, wherein the hot air blowing nozzle of said hot air die is disposed in correspondence with the joint face of the resin component to be heated.

4. The resin component welding apparatus according to claim 1, having a structure in which a space between the hot air blowing nozzle of the nozzle face of the hot air die located at the inserting position and the facing joint face of the resin component is from 0.1 to 10 mm, and the hot air blowing nozzle has a nozzle width of from 0.03 to 5 mm and a nozzle diameter of from φ0.05 to φ5 mm.

5. The resin component welding apparatus according to claim 1, wherein an air resistance member providing air resistance is laid in said hot air circuit.

6. The resin component welding apparatus according to claim 1, wherein said air resistance member has a die structure of special treatment and is a meshed or coiled structure.

7. The resin component welding apparatus according to claim 1, wherein the hot air die of said hot air generating structure is equipped with a guide for the hot air blowing nozzle.

8. The resin component welding apparatus according to claim 1, wherein said guide for the hot air blowing nozzle is made of guide ribs provided with a constant interval in said hot air die.

9. The resin component welding apparatus according to claim 1, wherein said hot air blowing nozzle has a structure in which it can be inserted into a narrow portion even for a structure or a shape having a deep groove in the joint face of the resin component to be heated.

10. The resin component welding apparatus according to claim 1, wherein the hot air generation mechanism of said hot air die includes a hot air blowing nozzle capable of bringing an appropriate molten state at an air pressure, an air volume, an air direction, and a temperature range suitable for welding.

11. The resin component welding apparatus according to claim 1, wherein a heat conductive medium in said resin component welding apparatus is air and/or a gas of higher specific heat.

12. The resin component welding apparatus according to claim 11, wherein said gas is one or more of hydrogen gas, helium gas, nitrogen gas, carbon dioxide gas, and argon gas.

13. A method of welding resin components, in which joint faces of two resin components formed of a thermoplastic resin are respectively heated into a molten state and pressure-bonded, and thereby the resin components are welding with each other on the joint faces, the method comprising:
a first step of supporting the respective resin components axially with the joint faces facing each other;
a second step of subsequently causing a hot air generating structure to get relatively close to the joint face of the respective resin component with a predetermined space;
a third step of subsequently blowing hot air from said hot air generating structure to heat the joint face of each of said resin components contactlessly into a molten state; and
a fourth step of thereafter pressure-contacting the joint faces of the respective resin components to each other for welding.

14. The method of welding resin components according to claim 13, wherein said hot air generating structure is a hot air blowing nozzle.

15. The method of welding resin components according to claim 13, wherein said hot air blowing nozzle is disposed in correspondence with the joint face of the resin component to be heated, and in said third step, the joint face of the resin component is simultaneously heated across an entire circumference thereof by the hot air blown from said hot air blowing nozzle.

16. The method of welding resin components according to claim 13, wherein, in said second step, said hot air blowing nozzle is caused to come close to the facing joint face of the resin component with a space of from 0.1 to 10 mm and has a structure having a nozzle width of from 0.03 to 5 mm and a nozzle diameter of from φ0.05 to φ5 mm.

17. The method of welding resin components according to claim 13, wherein, in said method of welding resin components, an air resistance member is laid said the hot air circuit.

18. The method of welding resin components according to claim 13, wherein said air resistance member has a die structure of special treatment and is a meshed or coiled structure.

19. The method of welding resin components according to claim 13, wherein, in said method of welding resin components, said hot air blowing nozzle has a structure in which it can be inserted into a narrow portion even for a structure or a shape having a deep groove in the joint face of the resin component to be heated.

20. The method of welding resin components according to claim 13, wherein, in said method of welding resin components, the hot air generating structure of said hot air die includes a hot air blowing nozzle capable of bringing an appropriate molten state at an air pressure, an air volume, an air direction, and a temperature range suitable for welding.

21. The method of welding resin components according to claim 13, wherein, in said method of welding resin components, a melting temperature is from 100 to 500° C.

22. The method of welding resin components according to claim 13, wherein, in, in said method of welding resin components, the hot air die of said hot air generating structure is equipped with a guide for the hot air blowing nozzle.

23. The method of welding resin components according to claim 13, wherein the guide for said hot air blowing nozzle is made of guide ribs provided with a constant interval in said hot air die.

24. The method of welding resin components according to claim 13, wherein the heat conductive medium in said method of welding resin components is air and/or a gas of higher specific heat.

25. The method of welding resin components according to claim 24, wherein said gas is one or more of hydrogen gas, helium gas, nitrogen gas, carbon dioxide gas, and argon gas.
